(19) United States
(12) Patent Application Publication
(10) Pub. No.: US 2026/0119762 A1
(43) Pub. Date: Apr. 30, 2026

(54) CREATION AND USAGE OF A BOOLEAN CIRCUIT DICTIONARY

(71) Applicant: INTERNATIONAL BUSINESS MACHINES CORPORATION, ARMONK, NY (US)

(72) Inventors: ZAHRAA SABRA, ATLANTA, GA (US); ZOLTAN TIBOR HIDVEGI, ROUND ROCK, TX (US); KEVIN ANTHONY PASNIK, JOHNSON CITY, TN (US); PAUL BUNCH, AUSTIN, TX (US)

(21) Appl. No.: 18/926,734

(22) Filed: Oct. 25, 2024

(51) Int. Cl. G06F 30/323; G06F 111/20

(52) U.S. Cl. CPC G06F 30/323; G06F 2111/20

(57) ABSTRACT

Creation and usage of a Boolean circuit dictionary, including: initializing a Boolean circuit dictionary based on a Boolean primitive dictionary; populating a plurality of circuit cost buckets of the Boolean circuit dictionary, wherein populating the plurality of circuit cost buckets comprises: selecting, for each circuit cost bucket, each combination of a stored circuit in the Boolean circuit dictionary and a primitive in the Boolean primitive dictionary having a combined cost equal to a cost value of a corresponding circuit cost bucket; and adding, to the corresponding circuit cost bucket of the Boolean circuit dictionary, any combination with a canonical form not having an existing entry in the Boolean circuit dictionary.

### BACKGROUND

The present disclosure relates to methods, apparatus, and products for creation and usage of a Boolean circuit dictionary.

### SUMMARY

According to embodiments of the present disclosure, various methods, apparatus and products for creation and usage of a Boolean circuit dictionary are described herein. In some aspects, creation and usage of a Boolean circuit dictionary includes initializing a Boolean circuit dictionary based on a Boolean primitive dictionary; populating a plurality of circuit cost buckets of the Boolean circuit dictionary, wherein populating the plurality of circuit cost buckets comprises: selecting, for each circuit cost bucket, each combination of a stored circuit in the Boolean circuit dictionary and a primitive in the Boolean primitive dictionary having a combined cost equal to a cost value of a corresponding circuit cost bucket; and adding, to the corresponding circuit cost bucket of the Boolean circuit dictionary, any combination with a canonical form not having an existing entry in the Boolean circuit dictionary. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a block diagram of an example computing environment for creation and usage of a Boolean circuit dictionary in accordance with some embodiments of the present disclosure.

FIG. 2 sets forth a flowchart of an example method for creation and usage of a Boolean circuit dictionary in accordance with some embodiments of the present disclosure.

FIG. 3 sets forth a flowchart of another example method for creation and usage of a Boolean circuit dictionary in accordance with some embodiments of the present disclosure.

FIG. 4 sets forth a flowchart of another example method for creation and usage of a Boolean circuit dictionary in accordance with some embodiments of the present disclosure.

FIG. 5 sets forth a flowchart of another example method for creation and usage of a Boolean circuit dictionary in accordance with some embodiments of the present disclosure.

FIG. 6 sets forth a diagram of an example Boolean primitive dictionary for creation and usage of a Boolean circuit dictionary in accordance with some embodiments of the present disclosure.

FIG. 7 sets forth a diagram of an example Boolean circuit dictionary for creation and usage of a Boolean circuit dictionary in accordance with some embodiments of the present disclosure.

FIG. 8 sets forth a diagram for combining Boolean circuits and primitives for creation and usage of a Boolean circuit dictionary in accordance with some embodiments of the present disclosure.

FIG. 9 sets forth a diagram for combining Boolean circuits and primitives for creation and usage of a Boolean circuit dictionary in accordance with some embodiments of the present disclosure.

### DETAILED DESCRIPTION

Boolean functions may have NPN (input negation, input permutation, and output negation) equivalent forms that may be implemented using the same circuit. Accordingly, multiple different circuits may be functionally equivalent but differing in their costs to implement. In order to minimize costs and more optimally use available space for circuits, it may be beneficial to use the lowest cost implementations of the canonical forms of Boolean functions.

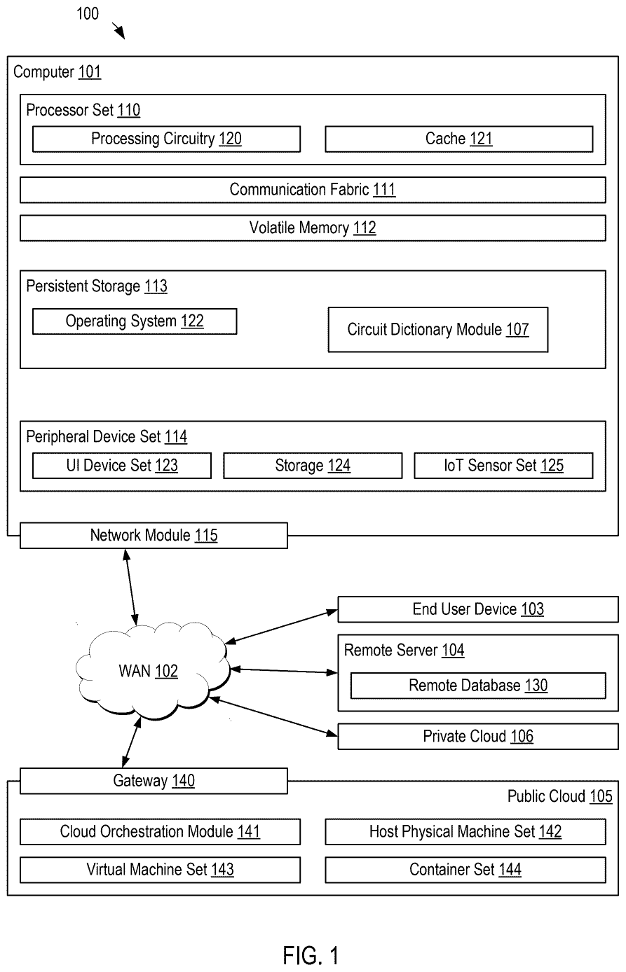

With reference now to FIG. 1, shown is an example computing environment according to aspects of the present disclosure. Computing environment 100 contains an example of an environment for the execution of at least some of the computer code involved in performing the various methods described herein, such as the circuit dictionary module 107. In addition to the circuit dictionary module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

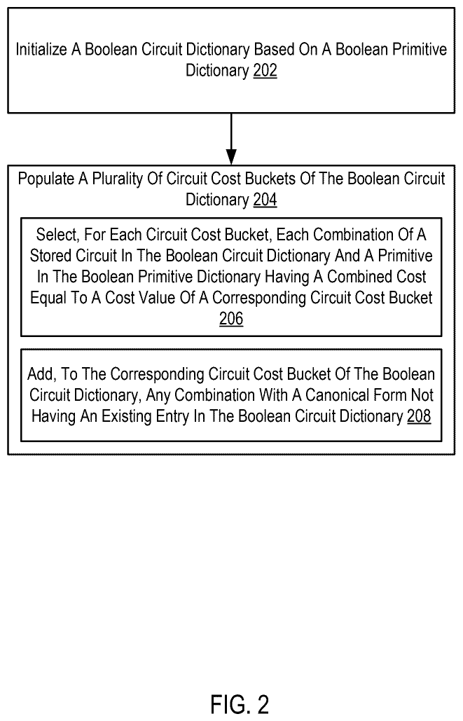

FIG. 2 sets forth a flowchart of an example method for creation and usage of a Boolean circuit dictionary in accordance with some embodiments of the present disclosure. The method of FIG. 2 may be performed, for example, using a circuit dictionary module 107 of FIG. 1. The method of FIG. 2 includes initializing a Boolean circuit dictionary based on a Boolean primitive dictionary. As described herein, each of the Boolean circuit dictionary and the Boolean primitive dictionary are data structures that include multiple cost buckets into which a Boolean circuit or Boolean primitive may be organized. A Boolean primitive is a logic gate for some Boolean function that accepts multiple inputs and provides a single output. A Boolean circuit includes one or more Boolean primitives. In other words, a Boolean circuit may include a single Boolean primitive or multiple interconnected Boolean primitives.

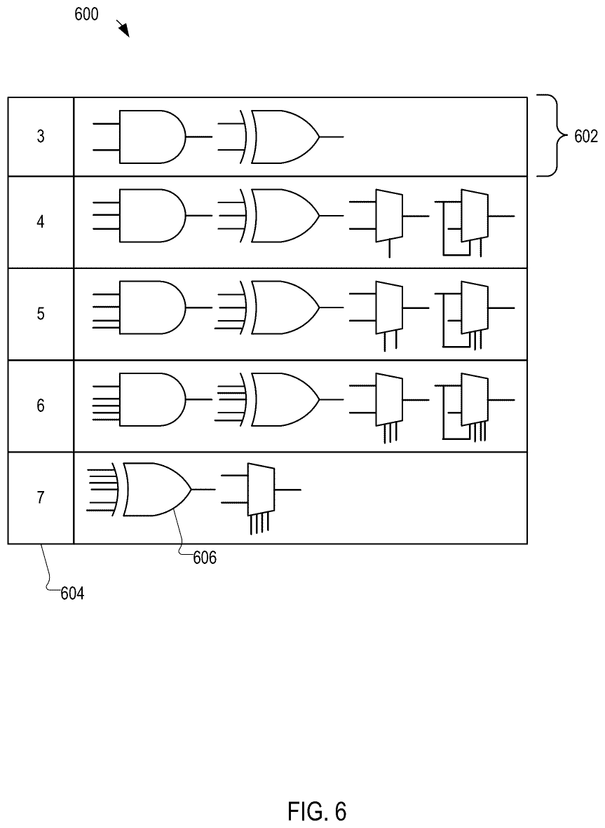

Referring to FIG. 6, shown is an example Boolean primitive dictionary 600 in accordance with some embodiments of the present disclosure. As shown, the Boolean primitive dictionary 600 includes multiple primitive cost buckets 602 each having a corresponding cost value 604 and one or more Boolean primitives 606. The cost value 604 for a given primitive 606 may be calculated and/or predefined according to a variety of approaches, such as based on the number of inputs and/or outputs to the primitive. Although the following Boolean primitive dictionary 600 shows Boolean primitives 606 up to a cost value 604 of seven, readers will appreciate that, in some embodiments, primitive cost buckets 602 with other cost values 604 may also be used.

Turning back to the method of FIG. 2, the Boolean circuit dictionary, once generated, will store, for various canonical Boolean functions, a lowest cost implementation. Accordingly, in order to generate this Boolean circuit dictionary, the Boolean circuit dictionary will be initialized to match the Boolean primitive dictionary. In other words, as each primitive in the Boolean primitive dictionary is the lowest cost implementation of its canonical form, the Boolean circuit dictionary will be populated with those primitives in their respective cost buckets.

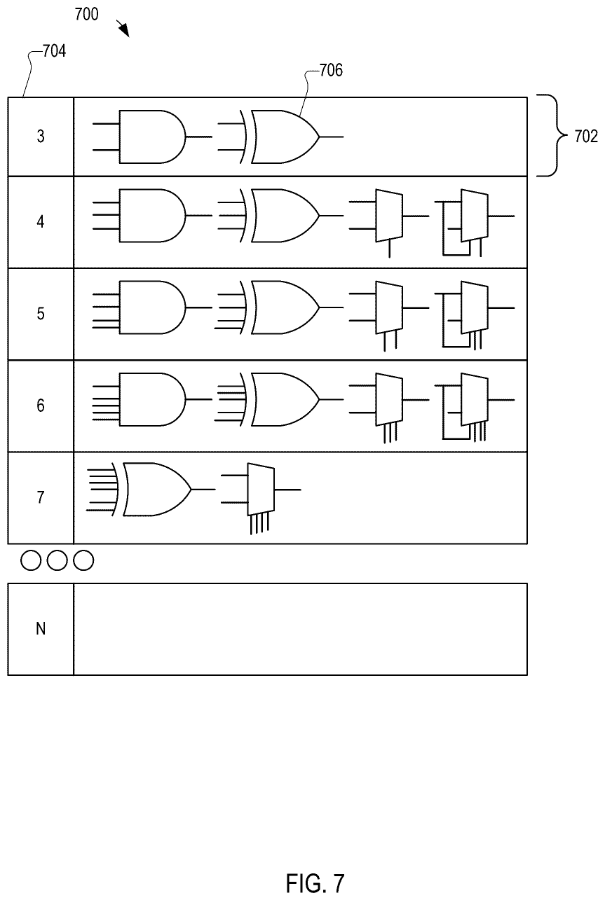

For example, FIG. 7 shows an example Boolean circuit dictionary 700 in accordance with some embodiments of the present disclosure. The Boolean circuit dictionary 700 includes multiple circuit cost buckets 702 with corresponding cost values 704 and circuits 706. Here, the circuits 706 initially added to the Boolean circuit dictionary 700 match the primitives 606 of the Boolean primitive dictionary 600 of FIG. 6. The Boolean circuit dictionary 700 also includes additional cost buckets 702 beyond those of the Boolean primitive dictionary 600 of FIG. 6 (e.g., up to a cost value of N) that will be populated with dynamically generated circuits as will be described in further detail below.

Turning back again to the method of FIG. 2, the method of FIG. 2 also includes populating 204 a plurality of circuit cost buckets of the Boolean circuit dictionary (e.g., the cost buckets 702 of the Boolean circuit dictionary 700). In some embodiments, populating 204 a plurality of circuit cost buckets of the Boolean circuit dictionary includes dynamically generating various circuits using the Boolean primitives of the Boolean primitive dictionary and circuits already stored in the Boolean circuit dictionary to determine the lowest-cost implementation of various canonical forms.

For example, in some embodiments, populating 204 a plurality of circuit cost buckets of the Boolean circuit dictionary includes selecting 206, for each circuit cost bucket, each combination of a stored circuit in the Boolean circuit dictionary and a primitive in the Boolean primitive dictionary having a combined cost equal to a cost value of a corresponding circuit cost bucket. In other words, for a given circuit cost bucket, a candidate circuit that may potentially be added to the given cost bucket may be generated by pairing some other circuit stored in the Boolean circuit dictionary with a Boolean primitive such that their combined costs are equal to the cost value of the given circuit cost bucket. In other words, the cost value for a given candidate circuit is the sum of the cost values for the circuit and primitive used to generate the given candidate circuit. In some embodiments, a circuit and a primitive may be combined by coupling an output of the primitive to an input of the stored circuit. In some embodiments, a circuit and a primitive may be combined by connecting one or more inputs of the primitive to one or more inputs of the circuit. This process is repeated for each possible pairing of stored circuits and primitives having a combined cost value equal to the given circuit cost bucket.

For example, in order to populate the circuit cost bucket of value six, each circuit already stored in the value three circuit cost bucket will be paired with each primitive of value three. As another example, in order to populate the circuit cost bucket of value seven, each circuit already stored in the value three circuit cost bucket will be paired with each primitive of value four, and each circuit already stored in the value four circuit cost bucket will be paired with each primitive of value three.

For each of these candidate circuits, it must be determined whether they should be added to the Boolean circuit dictionary. Readers will appreciate that many Boolean functions have NPN (input negation, input permutation, and output negation) equivalents that may be implemented using the same circuit. In some embodiments, the canonical form of a given circuit may include its NPN equivalent. In other words, two circuits may be deemed to share a canonical form where they are NPN equivalents of each other. Accordingly, a candidate circuit will be added to the Boolean circuit dictionary where it is the lowest cost implantation of its corresponding canonical form (e.g., of its NPN equivalents).

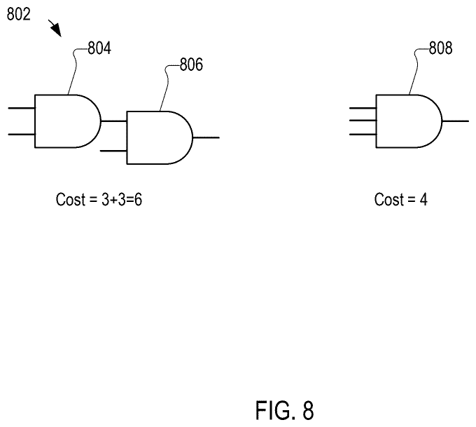

Turning to the example of FIG. 8, a candidate circuit 802 for a cost value of six may be generated by coupling the output of Boolean primitive 804 to the input of Boolean circuit 806, each having a cost value of three. This candidate circuit 802 is an NPN equivalent to the Boolean function implemented by circuit 808 having cost value four. In other words, candidate circuit 802 and circuit 808 share a canonical form. As the circuit 808 has a lesser cost value than the candidate circuit 802 sharing its canonical form, the candidate circuit 802 should not be added to the Boolean circuit dictionary.

In some embodiments, it may be assumed that any given circuit already stored in the Boolean circuit dictionary is the lowest cost implantation of its corresponding canonical form. Accordingly, in some embodiments, populating 204 a plurality of circuit cost buckets of the Boolean circuit dictionary also includes adding 208, to the corresponding circuit cost bucket of the Boolean circuit dictionary, any combination with a canonical form not having an existing entry in the Boolean circuit dictionary.

In some embodiments, where a given candidate circuit has an NPN equivalent circuit already stored in the Boolean circuit dictionary, it may be assumed that the already stored circuit is the lowest cost implementation a circuit having that canonical form (e.g., for any NPN equivalents). Where no NPN equivalent is found in the Boolean circuit dictionary, that candidate circuit may then be added to the Boolean circuit dictionary to the circuit cost bucket of its cost value. In some embodiments, where a given candidate circuit has an NPN-equivalent circuit stored in the Boolean circuit dictionary having the same cost as the given candidate circuit (e.g., stored in the same cost bucket into which the given candidate circuit would be stored), the given candidate circuit may be stored in the Boolean circuit dictionary as an alternative, same-cost implementation.

By iterating through and populating each circuit cost bucket of the Boolean circuit dictionary, the resulting Boolean circuit dictionary includes the lowest cost implementations for various Boolean functions. As will be described in further detail below, this Boolean circuit dictionary may be used for various purposes. For example, the Boolean circuit dictionary may be referenced to identify, for the canonical form of a given Boolean function (e.g., for any of its NPN equivalents), the lowest cost implementation. As another example, portions of circuit diagrams may be replaced with lowest cost implementations from the Boolean circuit dictionary to reduce the overall cost of the circuit.

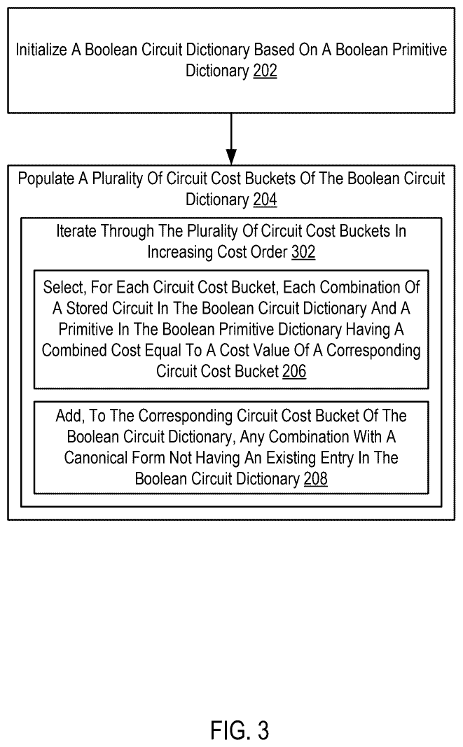

For further explanation, FIG. 3 sets forth a flowchart of another example method of creation and usage of a Boolean circuit dictionary in accordance with some embodiments of the present disclosure. The method of FIG. 3 is similar to FIG. 2 in that the method of FIG. 3 also includes initializing 202 a Boolean circuit dictionary based on a Boolean primitive dictionary; and populating 204 a plurality of circuit cost buckets of the Boolean circuit dictionary, including: selecting 206, for each circuit cost bucket, each combination of a stored circuit in the Boolean circuit dictionary and a primitive in the Boolean primitive dictionary having a combined cost equal to a cost value of a corresponding circuit cost bucket; and adding 208, to the corresponding circuit cost bucket of the Boolean circuit dictionary, any combination with a canonical form not having an existing entry in the Boolean circuit dictionary.

The method of FIG. 3 differs from FIG. 2 in that populating 204 a plurality of circuit cost buckets of the Boolean circuit dictionary includes iterating 302 through the plurality of circuit cost buckets in increasing cost order. In other words, populating 204 the plurality of circuit cost buckets may start from a circuit cost bucket to be populated having a lowest cost value. This may include, for example, the cost value that is double the lowers cost value primitive. For example, where primitives are stored beginning at a cost value of three, populating the plurality of circuit cost buckets may begin from cost value six.

After populating a given circuit cost bucket, the sequentially next circuit cost bucket may then be populated. This process repeats until the highest cost value circuit cost bucket has been populated. By iterating through the circuit cost buckets sequentially, this ensures that any circuit stored into the Boolean circuit dictionary is the lowest cost implementation for that canonical form. Thus, any subsequently generated candidate circuits sharing a canonical form (e.g., an NPN equivalence) with an existing entry in the Boolean circuit dictionary will necessarily have a greater or equal cost than the existing entry. This prevents computationally expensive operations for removing entries from the Boolean circuit dictionary.

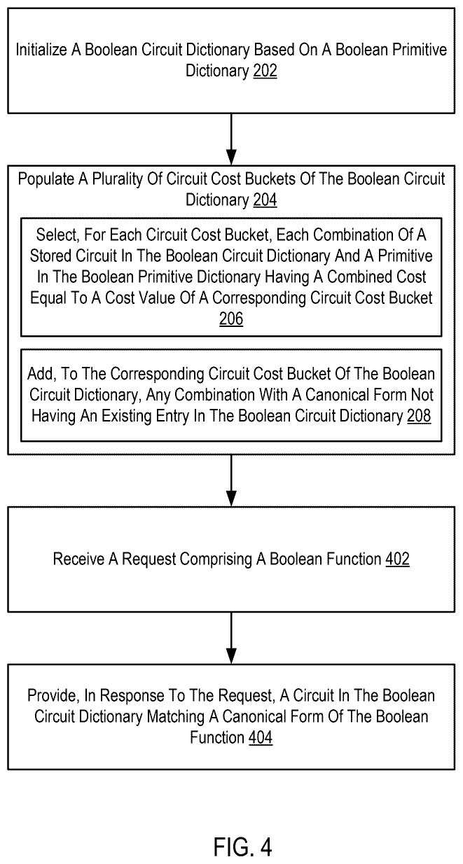

For further explanation, FIG. 4 sets forth a flowchart of another example method of creation and usage of a Boolean circuit dictionary in accordance with some embodiments of the present disclosure. The method of FIG. 4 is similar to FIG. 2 in that the method of FIG. 4 also includes initializing 202 a Boolean circuit dictionary based on a Boolean primitive dictionary; and populating 204 a plurality of circuit cost buckets of the Boolean circuit dictionary, including: selecting 206, for each circuit cost bucket, each combination of a stored circuit in the Boolean circuit dictionary and a primitive in the Boolean primitive dictionary having a combined cost equal to a cost value of a corresponding circuit cost bucket; and adding 208, to the corresponding circuit cost bucket of the Boolean circuit dictionary, any combination with a canonical form not having an existing entry in the Boolean circuit dictionary.

The method of FIG. 4 differs from FIG. 2 in that the method of FIG. 4 also includes receiving 402 a request comprising a Boolean function; and providing 404, in response to the request, a circuit in the Boolean circuit dictionary matching a canonical form of the Boolean function. As an example, in some embodiments, the Boolean circuit dictionary may be implemented or accessible to circuit design software or another application. A command may be provided via that software or application indicating a particular Boolean function to be implemented in a design. The Boolean circuit dictionary may be referenced to determine if there is a circuit matching or that is an NPN equivalent to the particular Boolean function. The corresponding circuit may then be provided in response. Thus, the provided circuit is the lowest cost implementation of the canonical form of the Boolean function included in the request, reducing overall cost of the designed circuit and providing for more optimal usage of design space. Moreover, this reduces build turn-around time, leading to faster model building and optimizing the design leads for faster simulation.

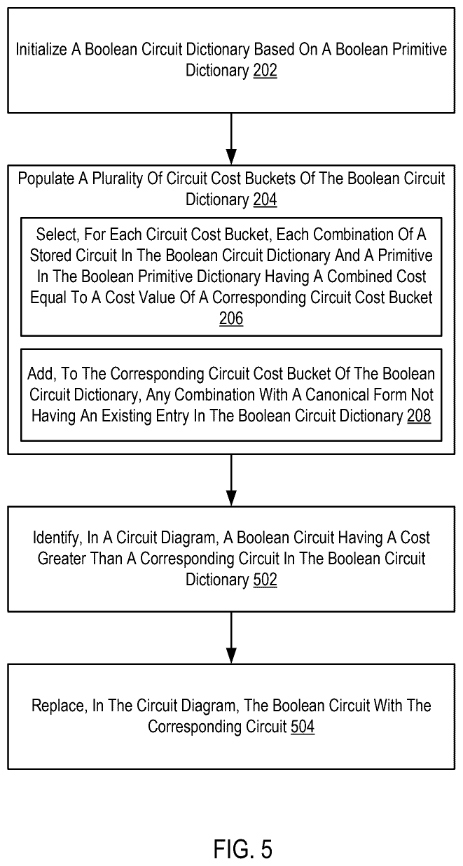

For further explanation, FIG. 5 sets forth a flowchart of another example method of creation and usage of a Boolean circuit dictionary in accordance with some embodiments of the present disclosure. The method of FIG. 5 is similar to FIG. 2 in that the method of FIG. 5 also includes initializing 202 a Boolean circuit dictionary based on a Boolean primitive dictionary; and populating 204 a plurality of circuit cost buckets of the Boolean circuit dictionary, including: selecting 206, for each circuit cost bucket, each combination of a stored circuit in the Boolean circuit dictionary and a primitive in the Boolean primitive dictionary having a combined cost equal to a cost value of a corresponding circuit cost bucket; and adding 208, to the corresponding circuit cost bucket of the Boolean circuit dictionary, any combination with a canonical form not having an existing entry in the Boolean circuit dictionary.

The method of FIG. 5 differs from FIG. 2 in that the method of FIG. 5 also includes identifying 502, in a circuit diagram, a Boolean circuit having a cost greater than a corresponding circuit in the Boolean circuit dictionary. For example, one or more portions of a circuit diagram implementing Boolean functions may be analyzed to identify any Boolean circuits implementing functions whose canonical forms correspond to a circuit in the Boolean circuit dictionary. Assuming that the function implemented by the identified Boolean circuit has a corresponding entry in the Boolean circuit dictionary, where the identified Boolean circuit does not match the entry in the Boolean circuit dictionary it may be assumed that the identified Boolean circuit has a cost greater than the entry in the Boolean circuit dictionary. This is due to the Boolean circuit dictionary storing the lowest cost version of the canonical form of the implemented function.

The method of FIG. 5 also includes replacing 504, in the circuit diagram, the Boolean circuit with the corresponding circuit. Thus, the identified Boolean circuit is replaced with a lower cost implementation of its canonical form from the Boolean circuit dictionary. This improves performance of the circuit, reduces cost, and more efficiently uses available space for circuits.

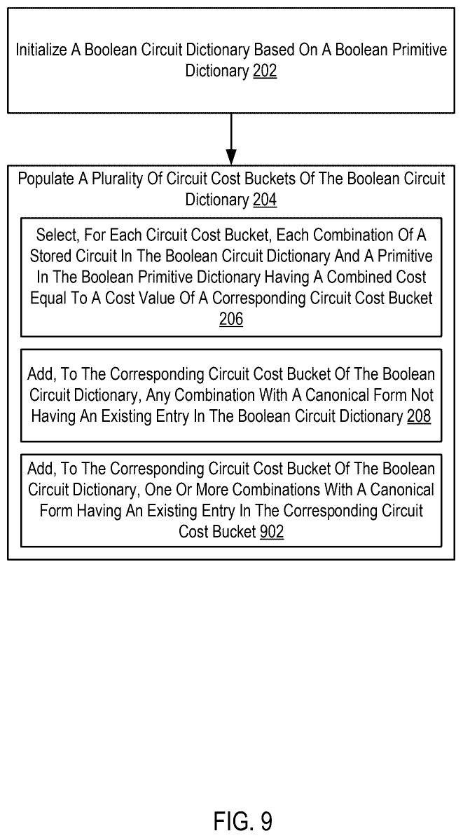

For further explanation, FIG. 9 sets forth a flowchart of another example method of creation and usage of a Boolean circuit dictionary in accordance with some embodiments of the present disclosure. The method of FIG. 9 is similar to FIG. 2 in that the method of FIG. 9 also includes initializing 202 a Boolean circuit dictionary based on a Boolean primitive dictionary; and populating 204 a plurality of circuit cost buckets of the Boolean circuit dictionary, including: selecting 206, for each circuit cost bucket, each combination of a stored circuit in the Boolean circuit dictionary and a primitive in the Boolean primitive dictionary having a combined cost equal to a cost value of a corresponding circuit cost bucket; and adding 208, to the corresponding circuit cost bucket of the Boolean circuit dictionary, any combination with a canonical form not having an existing entry in the Boolean circuit dictionary.

The method of FIG. 9 differs from FIG. 2 in that populating 204 a plurality of circuit cost buckets of the Boolean circuit dictionary also includes adding 902, to the corresponding circuit cost bucket of the Boolean circuit dictionary, one or more combinations with a canonical form having an existing entry in the corresponding circuit cost bucket. As is set forth above, a combination of a stored circuit in the Boolean circuit dictionary and a primitive in the Boolean circuit dictionary may be added to its corresponding circuit cost bucket (e.g., corresponding to the total cost of the combination) where the Boolean circuit dictionary does not already store an entry having the canonical form of the combination, indicating that no lower-cost canonical equivalent is currently stored in the Boolean circuit dictionary. In some embodiments, a canonical equivalent entry having an equal cost to the combination may be stored in the corresponding circuit cost bucket. Accordingly, in some embodiments, the combination may also be added 902 to the corresponding circuit cost bucket as an alternative implementation of the canonical form having the same cost as the already stored entry.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
initializing a Boolean circuit dictionary based on a Boolean primitive dictionary;
populating a plurality of circuit cost buckets of the Boolean circuit dictionary, wherein populating the plurality of circuit cost buckets comprises:
selecting, for each circuit cost bucket, each combination of a stored circuit in the Boolean circuit dictionary and a primitive in the Boolean primitive dictionary having a combined cost equal to a cost value of a corresponding circuit cost bucket; and
adding, to the corresponding circuit cost bucket of the Boolean circuit dictionary, any combination with a canonical form not having an existing entry in the Boolean circuit dictionary.

2. The method of claim 1, wherein the Boolean primitive dictionary comprises a plurality of primitive cost buckets each comprising one or more Boolean primitives.

3. The method of claim 1, wherein populating the plurality of circuit cost buckets comprises iterating through the plurality of circuit cost buckets in increasing cost order.

4. The method of claim 1, wherein the canonical form comprises an NPN equivalent.

5. The method of claim 1, wherein each combination of the stored circuit in the Boolean circuit dictionary and the primitive in the Boolean primitive dictionary comprises an output the primitive coupled to an input of the stored circuit.

6. The method of claim 5, wherein one or more inputs of the primitive are connected to one or more inputs of the stored circuit.

7. The method of claim 1, further comprising:
receiving a request comprising a Boolean function; and
providing, in response to the request, a circuit in the Boolean circuit dictionary matching a canonical form of the Boolean function.

8. The method of claim 1, further comprising:
identifying, in a circuit diagram, a Boolean circuit having a cost greater than a corresponding circuit in the Boolean circuit dictionary; and
replacing, in the circuit diagram, the Boolean circuit with the corresponding circuit.

9. The method of claim 1, wherein populating the plurality of circuit cost buckets further comprises adding, to the corresponding circuit cost bucket of the Boolean circuit dictionary, one or more combinations with a canonical form having an existing entry in the corresponding circuit cost bucket.

10. An apparatus comprising:
a memory; and
a processing device operatively coupled to the memory, the processing device configured to:
initialize a Boolean circuit dictionary based on a Boolean primitive dictionary;
populate a plurality of circuit cost buckets of the Boolean circuit dictionary, wherein, to populate the plurality of circuit cost buckets, the processing device is configured to:
select, for each circuit cost bucket, each combination of a stored circuit in the Boolean circuit dictionary and a primitive in the Boolean primitive dictionary having a combined cost equal to a cost value of a corresponding circuit cost bucket; and
add, to the corresponding circuit cost bucket of the Boolean circuit dictionary, any combination with a canonical form not having an existing entry in the Boolean circuit dictionary.

11. The apparatus of claim 10, wherein the Boolean primitive dictionary comprises a plurality of primitive cost buckets each comprising one or more Boolean primitives.

12. The apparatus of claim 10, wherein, to populate the plurality of circuit cost buckets, the processing device is further configured to iterate through the plurality of circuit cost buckets in increasing cost order.

13. The apparatus of claim 10, wherein the canonical form comprises an NPN equivalent.

14. The apparatus of claim 10, wherein each combination of the stored circuit in the Boolean circuit dictionary and the primitive in the Boolean primitive dictionary comprises an output the primitive coupled to an input of the stored circuit.

15. The apparatus of claim 14, wherein one or more inputs of the primitive are connected to one or more inputs of the stored circuit.

16. The apparatus of claim 10, wherein the processing device is further configured to:
receive a request comprising a Boolean function; and
provide, in response to the request, a circuit in the Boolean circuit dictionary matching a canonical form of the Boolean function.

17. The apparatus of claim 10, wherein the processing device is further configured to:
identify, in a circuit diagram, a Boolean circuit having a cost greater than a corresponding circuit in the Boolean circuit dictionary; and
replace, in the circuit diagram, the Boolean circuit with the corresponding circuit.

18. The apparatus of claim 10, wherein, to populate the plurality of circuit cost buckets, the processing device is further configured to add, to the corresponding circuit cost bucket of the Boolean circuit dictionary, one or more combinations with a canonical form having an existing entry in the corresponding circuit cost bucket.

19. A non-transitory computer readable storage medium storing instructions which, when executed, cause a processing device to:
initialize a Boolean circuit dictionary based on a Boolean primitive dictionary;
populate a plurality of circuit cost buckets of the Boolean circuit dictionary, wherein, to populate the plurality of circuit cost buckets, the instructions, when executed, cause the processing device to:
select, for each circuit cost bucket, each combination of a stored circuit in the Boolean circuit dictionary and a primitive in the Boolean primitive dictionary having a combined cost equal to a cost value of a corresponding circuit cost bucket; and
add, to the corresponding circuit cost bucket of the Boolean circuit dictionary, any combination with a canonical form not having an existing entry in the Boolean circuit dictionary.

20. The non-transitory computer readable storage medium of claim 19, wherein the Boolean primitive dictionary comprises a plurality of primitive cost buckets each comprising one or more Boolean primitives.
